(19) United States
(12) Patent Application Publication
(10) Pub. No.: US 2023/0297387 A1
(43) Pub. Date: Sep. 21, 2023

(54) CALCULATION APPARATUS, INTEGRATED CIRCUIT CHIP, BOARD CARD, ELECTRONIC DEVICE AND CALCULATION METHOD

(71) Applicant: CAMBRICON (XI'AN) SEMICONDUCTOR CO., LTD., Shaanxi (CN)

(72) Inventors: Xin YU, Shaanxi (CN); Shaoli LIU, Shaanxi (CN); Jinhua TAO, Shaanxi (CN)

(21) Appl. No.: 18/013,589

(22) PCT Filed: May 19, 2021
(86) PCT No.: PCT/CN2021/094722

§ 371 Date: Dec. 29, 2022

(30) Foreign Application Priority Data
Jun. 30, 2020 (CN) 202010619481.X

(51) Int. Cl. G06F 9/38; G06F 9/30

(52) U.S. Cl. CPC G06F 9/3871; G06F 9/3001

(57) ABSTRACT

A calculation apparatus is included in a combined processing apparatus, which also includes a general interconnection interface and other processing apparatuses. The calculation apparatus interacts with other processing apparatuses to jointly complete calculations specified by users. The combined processing apparatus also includes a storage apparatus. The storage apparatus is respectively connected to a device and other processing apparatuses and is used for storing data of the device and data of other processing apparatuses. Operational efficiency of calculation of every kind of data processing fields including an artificial intelligence field can be improved, thereby decreasing overall overheads and cost of the calculation.

### CROSS REFERENCE OF RELATED APPLICATION

This application claims benefit under 35 U.S.C. 119, 120, 121, or 365(c), and is a National Stage entry from International Application No. PCT/CN2021/094722, filed May 19, 2021, which claims priority to the benefit of Chinese Patent Application No. 202010619481.X filed in the Chinese Intellectual Property Office on Jun. 30, 2020, the entire contents of which are incorporated herein by reference.

### BACKGROUND

### 1. Technical Field

The present disclosure generally relates to a calculation field. More specifically, the present disclosure relates to a calculation apparatus, an integrated circuit chip, a board card, an electronic device and a calculation method.

### 2. Background Art

In a calculation system, an instruction set is a set of instructions configured to perform calculation and control the calculation system, and the instruction set plays an important role in improving performance of a calculation chip (such as a processor) in the calculation system. Every kind of existed calculation chips (especially chips in an artificial intelligence field) may complete each kind of general or specific control operations and data processing operations by utilizing a related instruction set. However, there are many defects in the existed instruction set. For example, the existed instruction set is limited by a hardware architecture, and has poor performance in flexibility. Further, many instructions may only finish a single operation, but executing of a plurality of operations may require many instructions, which may substantially lead to an increase in on-chip I/O (input/output) data throughput. Besides, the existed instruction still has room to be improved in execution speed, execution efficiency and power consumption on the chip.

### SUMMARY

To at least solve the above mentioned problems in the prior art, the present disclosure provides a hardware architecture of one group or a plurality of groups of pipeline calculation circuits that support multi-stage pipeline calculation. By using this hardware architecture to perform a calculation instruction, technical solutions of the present disclosure may obtain technical advantages in many aspects such as improving processing performance of hardware, decreasing power consumption, improving execution efficiency of calculation, and avoiding calculation overheads.

A first aspect of the present disclosure provides a calculation apparatus, including: one or a plurality of groups of pipeline calculation circuits configured to perform multi-stage pipeline calculation, where each group of the pipeline calculation circuits constitutes one multi-stage calculation pipeline, and the multi-stage calculation pipeline includes a plurality of calculation circuits arranged stage by stage. In response to a plurality of received calculation instructions, each stage of calculation circuits in the multi-stage calculation pipeline is configured to perform one corresponding calculation instruction in the plurality of calculation instructions, where the plurality of calculation instructions are obtained through partition of calculation instructions received by the calculation apparatus.

A second aspect of the present disclosure provides an integrated circuit chip, which includes the above mentioned calculation apparatus to be described in the following plurality of embodiments.

A third aspect of the present disclosure provides a board card, which includes the above mentioned integrated circuit chip to be described in the following plurality of embodiments.

A fourth aspect of the present disclosure provides an electronic device, which includes the above mentioned integrated circuit chip to be described in the following plurality of embodiments.

A fifth aspect of the present disclosure provides a method that uses the above mentioned calculation apparatus to perform the calculation, where the calculation apparatus includes one or a plurality of groups of pipeline calculation circuits; the method includes: configuring each group of the pipeline calculation circuits of the one group or the plurality of groups of pipeline calculation circuits to perform the multi-stage pipeline calculation, where each group of the pipeline calculation circuits constitutes one multi-stage calculation pipeline, and the multi-stage calculation pipeline includes a plurality of calculation circuits that are arranged stage by stage; and in response to receiving the plurality of calculation instructions, each stage of the calculation circuits in the multi-stage calculation pipeline is configured to perform one corresponding calculation instruction in the plurality of calculation instructions, where the plurality of calculation instructions are obtained through partition of the calculation instruction received by the calculation apparatus.

By using the calculation apparatus, the integrated circuit chip, the board card, the electronic device and the method of the present disclosure, the pipeline calculation may be performed efficiently, especially every kinds of multi-stage pipeline calculation in the artificial intelligence field. Further, technical solutions of the present disclosure may realize efficient calculation with the help of a unique hardware architecture, thereby improving whole performance of the hardware and decreasing calculation overheads.

### BRIEF DESCRIPTION OF THE DRAWINGS

By reading the following detailed description with reference to the drawings, the above-mentioned and other objects, features and technical effects of the exemplary embodiments of the present disclosure may become easier to understand. In the drawings, several embodiments of the present disclosure are shown in an exemplary but not in a restrictive manner, and the same or corresponding reference numerals indicate the same or corresponding parts of the embodiments.

FIG. 1 is a block diagram of a calculation apparatus, according to an embodiment of the present disclosure.

FIG. 2 is a block diagram of a calculation apparatus, according to another embodiment of the present disclosure.

FIGS. 3A, 3B and 3C are schematic diagrams of matrix transformation performed by a data conversion circuit, according to an embodiment of the present disclosure.

FIG. 4 is a block diagram of a calculation system, according to an embodiment of the present disclosure.

FIG. 5 is a simplified flowchart of a method of performing a calculation by using a calculation apparatus, according to an embodiment of the present disclosure.

FIG. 6 is a structural diagram of a combined processing apparatus, according to an embodiment of the present disclosure.

FIG. 7 is a structural diagram of a board card, according to an embodiment of the present disclosure.

### DETAILED DESCRIPTION

Technical solutions of the present disclosure provides a hardware architecture that supports multi-stage pipeline calculation. When the hardware architecture is implemented in a calculation apparatus, the calculation apparatus at least includes one group or a plurality of groups of pipeline calculation circuits, where each group of the pipeline calculation circuits may constitute multi-stage calculation pipeline of the present disclosure. In the multi-stage calculation pipeline, a plurality of calculation circuits may be arranged stage by stage. In an embodiment, when receiving a plurality of calculation instructions, each stage of calculation circuits in the above mentioned multi-stage calculation pipeline may be configured to perform one corresponding calculation instruction in the plurality of calculation instructions. With the help of the hardware architecture and the calculation instruction of the present disclosure, a parallel pipeline operation may be performed efficiently, which extends an application scenario of the calculation and also decreases the calculation overheads.

Technical solutions in the embodiments of the present disclosure are described clearly and completely hereinafter with reference to the drawings in the embodiments of the present disclosure. Obviously the embodiments to be described are merely some rather than all embodiments of the present disclosure. All other embodiments obtained by those skilled in the art based on the embodiments of the present disclosure without creative efforts shall fall within the protection scope of the present disclosure.

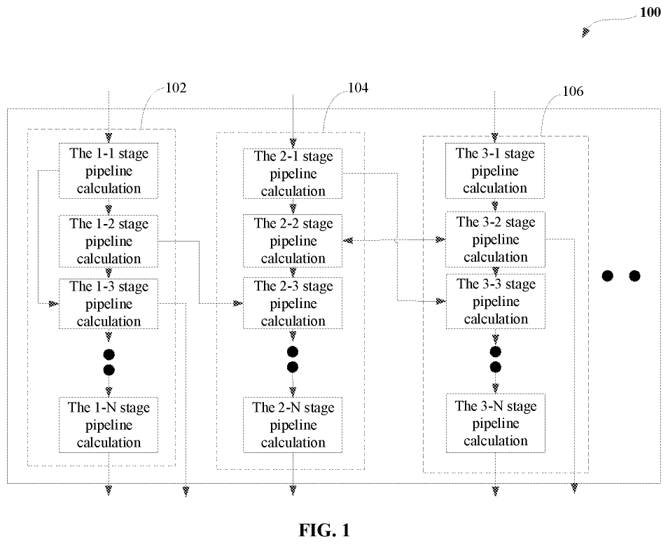

FIG. 1 is a block diagram of a calculation apparatus 100, according to an embodiment of the present disclosure. As shown in FIG. 1, the calculation apparatus 100 may include one group or a plurality of groups of pipeline calculation circuits, such as a first group of pipeline calculation circuits 102, a second group of pipeline calculation circuits 104 and a third group of pipeline calculation circuits 106 shown in FIG. 1, where each group of the pipeline calculation circuits may constitute one multi-stage calculation pipeline in context of the present disclosure. Taking the first group of pipeline calculation circuits 102 constituting a first multi-stage calculation pipeline as an example, the first group of pipeline calculation circuits 102 may perform N stages of pipeline calculations including a 1-1 stage pipeline calculation, a 1-2 stage pipeline calculation, a 1-3 stage pipeline calculation . . . and a 1-N stage pipeline calculation. Similarly, the second group and the third group of pipeline calculation circuits also have structures to support the N stages of pipeline calculations. Through such an exemplary architecture, those of ordinary skill in the art may understand that the plurality of groups of pipeline calculation circuits may constitute a plurality of multi-stage calculation pipelines, and the plurality of multi-stage calculation pipelines may perform their own plurality of calculation instructions in parallel.

In order to perform the above mentioned each stage of pipeline calculation, a calculation circuit including one or a plurality of calculation units may be arranged in each stage to perform corresponding calculation instructions to implement the calculation in the stage. In an embodiment, in response to a plurality of received calculation instructions, one or a plurality of groups of pipeline calculation circuits may be configured to perform multi-data calculation such as executing an SIMD (single instruction multi data) instruction. In an embodiment, the above mentioned plurality of calculation instructions may be obtained by parsing a calculation instruction received by the calculation apparatus 100, and an operation code of the calculation instruction may represent a plurality of operations performed by the multi-stage calculation pipeline. In another embodiment, the operation code and the plurality of operations represented by the operation code are determined in advance according to a function supported by the plurality of calculation circuits, where the plurality of calculation circuits are arranged stage by stage in the multi-stage calculation pipeline.

In technical solutions of the present disclosure, each group of the pipeline calculation circuits, except for executing the calculation stage by stage in one multi-stage calculation pipeline constituted by the group of pipeline calculation circuits, may also be configured to perform optional connection according to a plurality of calculation instructions to complete the corresponding plurality of calculation instructions. In an implementation scenario, the plurality of multi-stage calculation pipelines of the present disclosure may include the first multi-stage calculation pipeline and the second multi-stage calculation pipeline, where an output end of one stage or multi-stage of the calculation circuits of the first multi-stage calculation pipeline is configured to be connected to with an input end of one stage or multi-stage calculation circuits of the second multi-stage calculation pipeline according to the calculation instruction. For example, the 1-2 stage pipeline calculation of the first multi-stage calculation pipeline shown in the figure may output a calculation result to a 2-3 stage pipeline calculation of the second multi-stage calculation pipeline according to the calculation instruction. Similarly, a 2-1 stage pipeline calculation of the second multi-stage calculation pipeline shown in the figure may output a calculation result to a 3-3 stage pipeline calculation of the third multi-stage calculation pipeline according to the calculation instruction. In some scenarios, according to different calculation instructions, 2 stages of pipeline calculations in different calculation pipelines may realize bidirectional transfer of calculation results, such as a bidirectional transfer of calculation results between a 2-2 stage pipeline calculation of the second multi-stage calculation pipeline and a 3-2 stage pipeline calculation of the third multi-stage calculation pipeline shown in the figure.

It may be seen that in order to realize data transfer in the same calculation pipeline and between different calculation pipelines, each stage of calculation circuits in the plurality of groups of calculation pipelines of the present disclosure may have an input end and an output end, where the input end is configured to receive input data at the calculation circuit, and the output end is configured to output an operation result of the calculation circuit of this stage. In multi-stage calculation pipeline, an output end of one stage or multi-stage calculation circuits is configured to be connected to an input end of another one stage or multi-stage calculation circuits according to the calculation instruction, so as to perform the calculation instruction. For example, in a first calculation pipeline, a result of a 1-1 stage pipeline calculation may be input into a 1-3 stage pipeline calculation in the first calculation pipeline according to the calculation instruction.

In context of the present disclosure, the above mentioned plurality of calculation instructions may be microinstructions or control signals operated in the calculation apparatus (or a processing circuit, or a processor), and the plurality of calculation instructions may include (or specify) one or a plurality of calculations required to be performed by the calculation apparatus. According to different calculation scenarios, the calculation may include, but may not be limited to an addition operation, a multiplication operation, a convolution calculation, a pooling operation, and the like. In order to realize the multi-stage pipeline calculation, each stage of the calculation circuits that performs each stage of the pipeline calculation may include but may not be limited to following one or a plurality of calculation units or circuits: a random number processing circuit, an adding and subtracting circuit, a subtracting circuit, a look-up table circuit, a parameter configuration circuit, a multiplier, a pooler, a comparator, an absolute value circuit, a logic operator, a position index circuit or a filter. Taking the pooler as an example, the pooler may be exemplarily composed of such calculation units as an adder, a divider, a comparator and the like, so as to perform a pooling operation in the neural network.

In order to realize the multi-stage pipeline calculation, the present disclosure may provide corresponding calculation instructions according to the calculation supported by the calculation circuits in the multi-stage pipeline calculation, so as to realize the multi-stage pipeline calculation. According to different calculation scenarios, the calculation instruction of the present disclosure may include a plurality of operation codes, which may represent a plurality of operations performed by the calculation circuit. For example, in FIG. 1, when N=4 (when a 4-stage pipeline calculation is performed), the calculation instruction according to the technical solutions of the present disclosure may be represented as formula (1).

Result=((((scr0op0scr1)op1src2)op2src3)op3src4) (1),

where scr0 to scr4 are source operands, and op0 to op3 are operation codes. According to different architectures of the pipeline calculation circuits and different operations supported by the pipeline calculation circuits, type, order and number of the operation code of the calculation instruction in the present disclosure may be changed.

In some application scenarios, the multi-stage pipeline calculation of the present disclosure may support a unary calculation (calculation with only one piece of input data). Taking calculation at a scale layer+ relu layer in the neural network as an example, supposing a to-be-executed calculation instruction is represented as result=relu (a*ina+b), where ina is input data (such as a vector or a matrix), and a and b are calculation constants. For this calculation instruction, a group of 3-stage pipeline calculation circuits provided in the present disclosure, including a multiplier, an adder, and a nonlinear arithmetic unit, may be configured to perform the calculation. Specifically, a multiplication result of the input data ina and a may be computed by using the multiplier of the first-stage pipeline, so as to obtain a result of the first-stage pipeline calculation. Then, an adder of the second-stage pipeline may be utilized to add the result of the first-stage pipeline calculation (a*ina) and b to obtain a result of the second-stage pipeline calculation. Finally, a relu activation function of a third-stage pipeline may be utilized to activate the result of the second-stage pipeline calculation (a*ina+b) to obtain a final calculation result.

In some application scenarios, the multi-stage pipeline calculation circuits of the present disclosure may support a binary calculation (such as a convolution calculation instruction result=conv (ina, inb) or a ternary calculation (such as a convolution calculation instruction result=conv (ina, inb, bias)), where the input data ina, inb and bias may be a vector (such as integer data, fixed-point data or floating-point data), or may be a matrix. Taking the convolution calculation instruction result=conv (ina, inb) as an example, a plurality of multipliers, at least one adder tree and at least one nonlinear arithmetic unit that are included in a 3-stage pipeline calculation circuit structure may be utilized to perform the convolution calculation expressed by the calculation instruction, where two input data ina and inb may be neuron data. Specifically, a first-stage pipeline multiplier in the third-stage pipeline calculation circuits may be used to perform calculation, thereby a result product=ina*inb (which is seen as a microinstruction in the calculation instruction, and the calculation result corresponds to a multiplication) of the first-stage pipeline calculation may be obtained. Then, an adder tree of the second-stage pipeline calculation circuits may be utilized to perform addition on the calculation result “product” of the first-stage pipeline calculation to obtain a result sum of the second-stage pipeline calculation. Finally, a nonlinear arithmetic unit of the third-stage pipeline calculation circuits is utilized to activate the “sum”, so as to obtain a final convolution calculation result.

In some application scenarios, as mentioned before, the technical solutions of the present disclosure may perform a bypass operation on a one stage or multi-stage pipeline calculation circuits that may not be used in the calculation; in other words, one stage or multi-stage of the multi-stage pipeline calculation circuits may be used optionally according to demands of the calculation, and the calculation is not required to pass all the multi-stage pipeline operation. Taking a calculation of computing the Euclidean distance as an example, supposing the calculation instruction of this calculation is expressed as dis=sum((ina−inb)\hat{ }2), multi-stage pipeline calculation circuits composed of an adder, a multiplier, an adder tree and an accumulator is used to perform calculation, so as to obtain a final calculation result. A bypass operation may be performed on the pipeline calculation circuit that is not used in the calculation before or in the pipeline calculation.

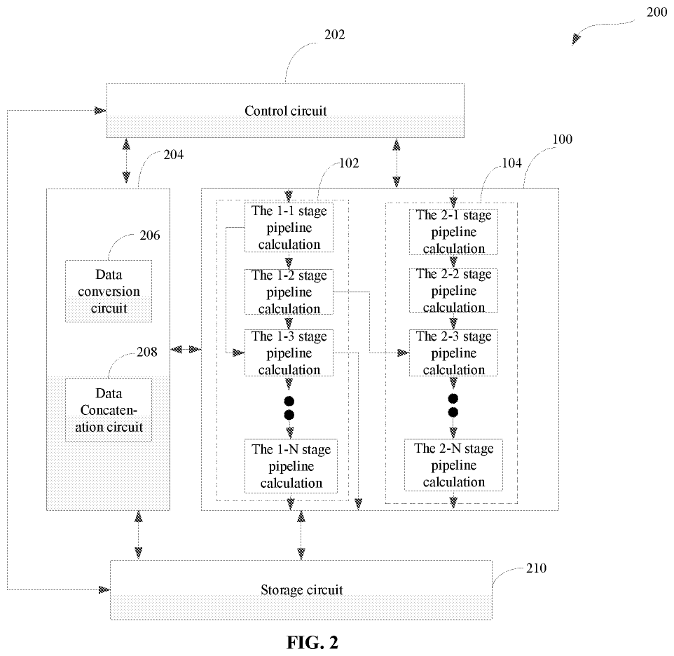

FIG. 2 is a block diagram of a calculation apparatus 200, according to another embodiment of the present disclosure. It may be seen from FIG. 2 that the calculation apparatus 200 not only has a group of pipeline calculation circuits 102 and a group of pipeline calculation circuits 104 that are same to the calculation apparatus 100, the calculation apparatus 200 additionally includes a control circuit 202 and a data processing circuit 204. In an embodiment, the control circuit 202 may be configured to obtain and parse the above mentioned calculation instruction, so as to obtain the plurality of calculation instructions corresponding to the plurality of operations expressed by the operation code, as shown in formula (1).

In an embodiment, the data processing unit 204 may include a data conversion circuit 206 and a data concatenation circuit 208. When the calculation instruction includes a preprocessing operation for the pipeline calculation, such as a data conversion operation or a data concatenation operation, the data conversion circuit 206 or the data concatenation circuit 208 may perform corresponding conversion operation or concatenation operation according to corresponding calculation instructions. The following examples will illustrate the conversion operation and the concatenation operation.

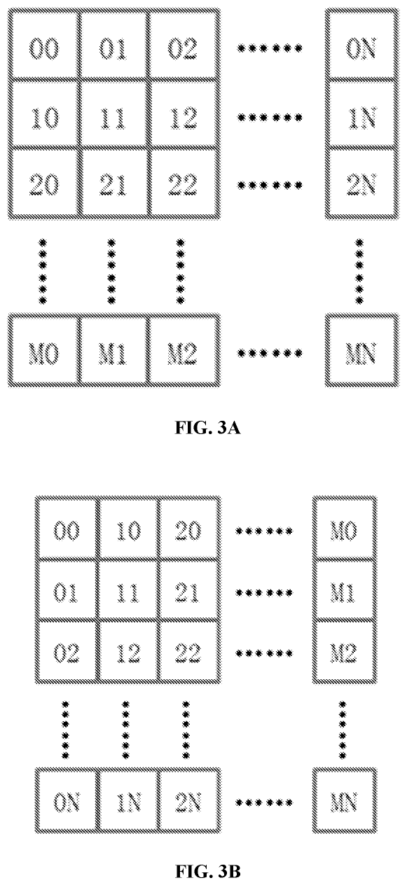

For the data conversion operation, when bit width of data input into the data conversion circuit is relatively wide (for example, data bit width is 1024 bits), the data conversion circuit may convert the input data to data with relatively low bit width according to calculation requirements (for example, bit width of output data is 512 bits). According to different application scenarios, the data conversion circuit may support conversions among a plurality of data types. For example, the conversions may be performed among data types with different bit width, such as FP16 (16-bit floating point number), FP32 (32-bit floating point number), FIX8 (8-bit fixed point number), FIX4 (4-bit fixed point number), and FIX16 (16-bit fixed point number), and the like. When data input into the data conversion circuit is a matrix, the data conversion operation may be a conversion with respect to arrangement positions of matrix elements. The conversion, for example, may include matrix transposing and mirror (which may be described in combination with FIG. 3A to FIG. 3C), rotation of the matrix according to a predetermined angle (such as 90 degrees, 180 degrees or 270 degrees), and conversion of dimensions of the matrix.

In terms of the data concatenation operation, the data concatenation circuit may perform operations such as parity concatenation of data blocks extracted from the data according to, for example, bit length set in an instruction. For example, when bit length of the data is 32 bits, the data concatenation circuit may split the data to 8 data blocks according to the bit width of 4 bits, and then splice data blocks 1, 3, 5, and 7 together, data blocks 2, 4, 6, and 8 together for calculation.

In some other application scenarios, the above mentioned data concatenation operation may be performed on data M (which may be a vector) obtained after the calculation. It is supposed that the data concatenation circuit may split low-order 256 bits in even lines of the data M with 8-bit width as a unit to obtain 32 even-line bits data (which may be respectively expressed as M_2i₀ to M_2i₃₁). Similarly, the data concatenation circuit may split low-order 256 bits in odd lines of the data M with 8-bit width as a unit to obtain 32 odd-line bits data (which may be respectively expressed as M_(2i+1)₀ to M_(2i+1)₃₁). Further, according to the order of the data bits from low to high, the even-numbered rows first and then the odd-numbered rows, the 32 odd-numbered row unit data and the 32 even-numbered row unit data after splitting are alternately arranged in turn. Specifically, the even-line unit data 0 (M_2i₀) may be arranged in a low bit, and the odd-line unit data 0 (M_(2i+1)₀) may be arranged sequentially, and then, an even-line unit data 1 (M_2i₁) is arranged . . . Similarly, when the arrangement of an odd-line unit data 31 (M_(2i+1)₃₁) is finished, 64 unit data is spliced together to form a new piece of data with 512-bit width.

According to different application scenarios, the data conversion circuit and the data concatenation circuit in the data processing unit may cooperate to perform a preprocessing operation or a post-processing operation of data flexibly. For example, according to different operations included in the calculation instruction, the data processing unit may only perform the data conversion operation but not perform the data concatenation operation, or only perform the data concatenation operation but not perform the data conversion operation, or perform both the data conversion operation and the data concatenation operation. In some scenarios, when the calculation instruction does not include the preprocessing operation that aims at the pipeline calculation, the data processing unit may be configured to disable using of the data conversion circuit and the data concatenation circuit. In some other scenarios, when the calculation instruction includes the post-processing operation that aims at the pipeline calculation, the data processing unit may be configured to enable the data conversion circuit and the data concatenation circuit to perform post-processing to an intermediate result data, thereby obtaining a final calculation result.

In order to realize a data storage operation, the calculation apparatus 200 further includes a storage circuit 210. In an application scenario, the storage circuit of the present disclosure may include a main storage unit and/or a main caching unit, where the main storage unit is configured to store data used for the multi-stage pipeline calculation and store the calculation result after the calculation is performed, and the main caching unit is configured to cache an intermediate calculation result after the calculation is performed in the multi-stage pipeline calculation. Further, the storage circuit may also have an interface configured to perform data transfer with an off-chip storage medium, thereby realizing data transfer between an on-chip system and an off-chip system.

FIGS. 3A, 3B and 3C are schematic diagrams of matrix transformations performed by the data conversion circuit, according to embodiments of the present disclosure. In order to better understand a conversion operation performed by the data conversion circuit 206, the following may take a transpose operation and a horizontal mirror operation performed by an original matrix as an example for further description.

As shown in FIG. 3A, the original matrix is a matrix with (M+1) lines and (N+1) rows. According to demands of application scenarios, the data conversion circuit may perform a transpose operation conversion to the original matrix shown in FIG. 3A to obtain a matrix shown in FIG. 3B. Specifically, the data conversion circuit may switch the row numbers of the elements in the original matrix with the column numbers to form a transpose matrix. Specifically, coordinates of an element “10” in the original matrix shown in FIG. 3A are line 1 and row 0, and in a transpose matrix shown in FIG. 3B, coordinates of the element “10” is line 0 and row 1. Similarly, coordinates of an element “M0” in the original matrix shown in FIG. Aa are line M+1 and row 0, and in the transpose matrix shown in FIG. 3B, coordinates of the element “M0” is line 0 and row M+1.

As shown in FIG. 3C, the data conversion circuit may perform a horizontal mirror operation to the original matrix shown in FIG. 3A, so as to form a horizontal mirror matrix. Specifically, the data conversion circuit may convert an arrangement order of elements of the original matrix from a first line to a last line to an arrangement order of elements from the last line to the first line through the horizontal mirror operation, but row numbers of elements in the original matrix may be kept unchanged. Specifically, coordinates of an element “00” in the original matrix shown in FIG. 3A are line 0 and row 0, and in the horizontal mirror matrix shown in FIG. 3C, coordinates of the element “00” is line M+1 and row 0; and coordinates of an element “10” in the original matrix shown in FIG. 3A are line 1 and row 0, and in the horizontal mirror matrix shown in FIG. 3C, coordinates of the element “10” is line M and row 0. Similarly, the coordinates of the element “M0” in the original matrix shown in FIG. 3A are line M+1 and row 0, and in the horizontal mirror matrix shown in FIG. 3C, coordinates of the element “M0” is line 0 and row 0.

Based on a hardware architecture shown in FIGS. 3A to 3C, the calculation apparatus of the present disclosure may perform calculation instructions that include the above mentioned preprocessing and post-processing. The following gives two exemplary examples according to calculation instructions of technical solutions of the present disclosure.

Example1:MUAD=(FPMULT)+(FPADD/FPSUB)+(RELU)+(CONVERTFP2FIX) (2).

The calculation instruction expressed in formula (2) is a calculation instruction that instructs to input a ternary operand and output a unary operand, and the calculation instruction includes a microinstruction that may be finished by a group of pipeline calculation circuits that includes a 3-stage pipeline calculation (multiplication+addition/subtraction+activation) of the present disclosure. Specifically, a ternary operation is A*B+C, where a microinstruction of FPMULT is performed to complete a floating-point number multiplication between an operand A and an operand B, so as to obtain a multiplication result, which is the first-stage pipeline calculation. Then, a microinstruction of FPADD or FPSUB is performed to finish a floating point number addition or subtraction operation between the above mentioned multiplication value and C, so as to obtain an addition result or a subtraction result, which is the second-stage pipeline calculation. Then, an activation operation RELU may be performed to the result in the pre-stage, and this is the third-stage pipeline calculation. Through the 3-stage pipeline calculation, a type conversion circuit may be used to perform an microinstruction CONVERTFP2FIX to convert the result after the activation operation from a floating point number to a fixed point number, so that the data may be output as a final result or input to a fixed point arithmetic unit as an intermediate result for further calculation.

Example2:□SECMUADC=SEARCHC+MULT+ADD (3).

The calculation instruction expressed in formula (3) is a calculation instruction that instructs to input a ternary operand and output a unary operand, and the calculation instruction includes a microinstruction that may be finished by a group of pipeline calculation circuits that includes a 3-stage pipeline calculation (look-up table+multiplication+addition) of the present disclosure. Specifically, a ternary operation is ST (A)*B+C, where a microinstruction of SEARCHC may be finished by a look-up table circuit in the first-stage pipeline calculation, so as to obtain a result A of the look-up table. Then, a multiplication operation between an operand A and an operand B may be finished by the 2-stage pipeline calculation to obtain a multiplication result. Next, a microinstruction of ADD may be performed to finish an addition operation between the above mentioned multiplication value and C, so as to obtain an addition result, which is the third-stage pipeline calculation.

As mentioned before, the calculation instruction of the present disclosure may be flexibly designed and determined according to demands of the calculation; so that the hardware architecture that includes a plurality of calculation pipelines of the present disclosure may be designed and connected according to the calculation instruction and a plurality of types of microinstructions (or micro operations) included in the calculation instruction. Therefore, a plurality of calculations may be completed through one calculation instruction, so that execution efficiency of the instruction may be improved, and calculation overheads may be decreased.

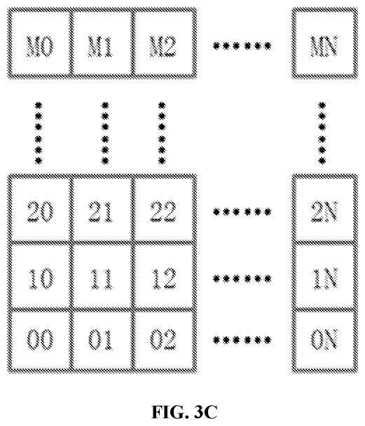

FIG. 4 is a block diagram of a calculation system 400, according to an embodiment of the present disclosure. It may be seen from FIG. 4, except for the calculation apparatus 200, the calculation system further includes a plurality of secondary processing circuits 402 and an interconnection unit 404 configured to connect the calculation apparatus 200 and the plurality of secondary processing circuits 402.

In a calculation scenario, the secondary processing circuit of the present disclosure may compute data that used in preprocessing in the calculation apparatus according to the calculation instruction (which, for example, may be implemented as one or a plurality of microinstructions or control signals) to obtain an expected calculation result. In another calculation scenario, the secondary processing circuit may send the intermediate result (such as through the interconnection unit) obtained after the calculation to the data processing unit in the calculation apparatus. Therefore, the data conversion circuit in the data processing unit may perform data type conversion to the intermediate result or the data concatenation circuit in the data processing unit may perform data partition and concatenation operation to the intermediate result, thereby a final calculation result may be obtained.

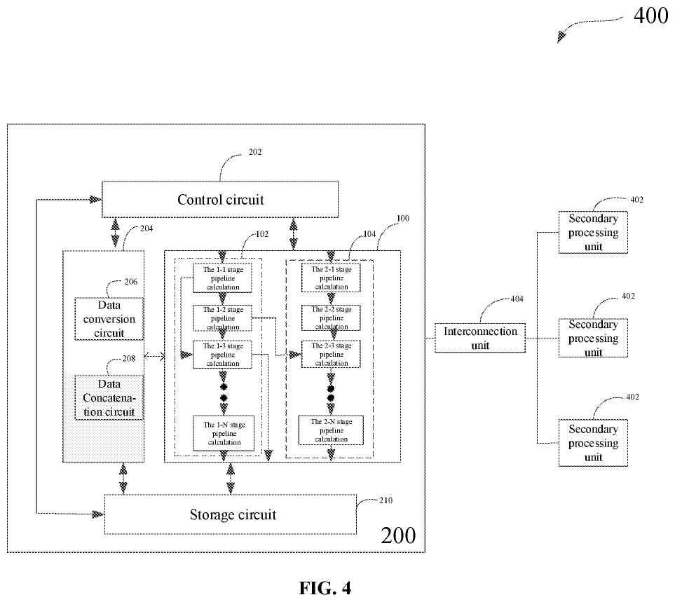

FIG. 5 is a simplified flowchart of a method 500 of performing a calculation by using the calculation apparatus, according to an embodiment of the present disclosure. According to the above mentioned description, it may be understood that the calculation apparatus here may be the calculation apparatus described with FIG. 1 to FIG. 4, and the calculation apparatus has the shown inner connection relation and supports additional types of operations.

As shown in FIG. 5, at a step 502, each group of the one group or the plurality of groups of pipeline calculation circuits is configured to perform the multi-stage pipeline calculation in a method 500. Each group of the pipeline calculation circuits constitutes one multi-stage calculation pipeline, and the multi-stage calculation pipeline includes a plurality of calculation circuits that are arranged stage by stage. Next, at step 504, the method 500, in response to receiving the plurality of calculation instructions, configures each stage of the calculation circuits in the above mentioned multi-stage calculation pipeline to perform one corresponding calculation instruction in the plurality of calculation instructions, where the plurality of calculation instructions are obtained through partition of the calculation instruction received by the calculation apparatus.

For simplicity, a calculation method of the present disclosure is described in combination with FIG. 5. Those of ordinary skill in the art may conceive, according to disclosed contents of the present disclosure that the method may include more steps, and execution of these steps may realize all types of operations described in combination with FIG. 1 to FIG. 4 of the present disclosure, which will not be repeated herein.

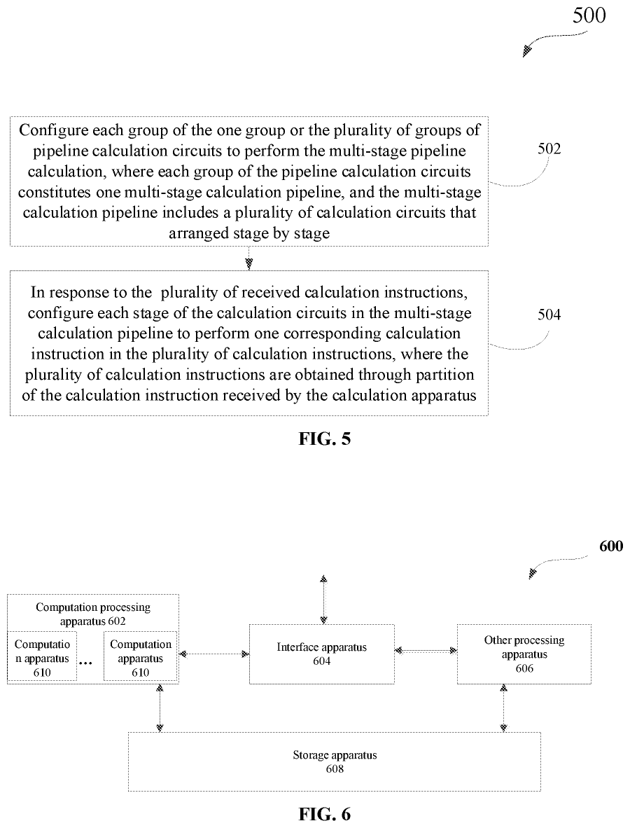

FIG. 6 is a structural diagram of a combined processing apparatus 600, according to an embodiment of the present disclosure. As shown in FIG. 6, the combined processing apparatus 600 includes a calculation processing apparatus 602, an interface apparatus 604, other processing apparatus 606 and a storage apparatus 608. According to different application scenarios, the calculation processing apparatus may include one or a plurality of calculation apparatuses 610, where the calculation apparatus may be configured to perform operations described in combination with FIG. 1 to FIG. 5.

In different embodiments, the calculation processing apparatus of the present disclosure may be configured to perform operations specified by the user. In exemplary applications, the calculation processing apparatus may be implemented as a single-core artificial intelligence processor or a multi-core artificial intelligence processor. Similarly, one or a plurality of calculation apparatuses included in the calculation processing apparatus may be implemented as an artificial intelligence processor core or a part hardware structure of the artificial intelligence processor core. When the plurality of calculation apparatuses are implemented as artificial intelligence processor cores or parts hardware structure of the artificial intelligence processor core, the calculation processing apparatus of the present disclosure may be regarded as having a single-core structure or a homogeneous structure.

In exemplary operations, the calculation apparatus of the present disclosure may interact with other processing apparatuses through an interface apparatus to jointly complete operations specified by the user. According to different implementation methods, other processing apparatuses of the present disclosure may include one or a plurality of types of general processors or special purpose processors like a central processing unit (CPU), a graphics processing unit (GPU), and an artificial intelligence processor. These processors may include but are not limited to a digital signal processor (DSP), an application-specific integrated circuit (ASIC), a field programmable gate array (FPGA), or other programmable logic components, discrete gate, transistor logic components, discrete hardware components, and the like, and the number of these processors may be determined according to real demands. As mentioned before, the calculation processing apparatus of the present disclosure may be regarded as having a single-core structure or a homogeneous structure. However, when both the calculation processing apparatus and other processing apparatuses are considered, both of the calculation processing apparatus and other processing apparatuses may be considered as forming a heterogeneous multi-core structure.

In one or more embodiments, other processing apparatuses may serve as an interface that connects the calculation processing apparatus (which may be specified as an artificial intelligence calculation apparatus such as a calculation apparatus related to a neural network calculation) of the present disclosure to external data and control to perform basic controls, including but are not limited to data moving, and starting and/or stopping the calculation apparatus. In other embodiments, other processing apparatuses may also cooperate with the calculation processing apparatus to complete calculation tasks.

In one or a plurality of embodiments, the interface apparatus may also be configured to transfer data and control instructions between the calculation processing apparatus and other processing apparatuses. For example, the calculation processing apparatus may obtain input data from other processing apparatuses through the interface apparatus, and write the input data to an on-chip storage apparatus (or called a memory) on the calculation processing apparatus. Further, the calculation processing apparatus may obtain a control instruction from other processing apparatuses through the interface apparatus, and write the control instruction to an on-chip control caching unit on the calculation processing apparatus. Alternatively or optionally, the interface apparatus may read data in the storage apparatus of the calculation processing apparatus and transfer the data to other processing apparatuses.

Additionally or optionally, a combined processing apparatus of the present disclosure may further include a storage apparatus. As shown in the figure, the storage apparatus is respectively connected to the calculation processing apparatus and other processing apparatuses. In one or a plurality of embodiments, the storage apparatus may also be configured to store data of the calculation processing apparatus and/or data of other processing apparatuses. For example, the data may be data that may not be entirely stored in an inner storage apparatus or an on-chip storage apparatus of the calculation processing apparatus or other processing apparatuses.

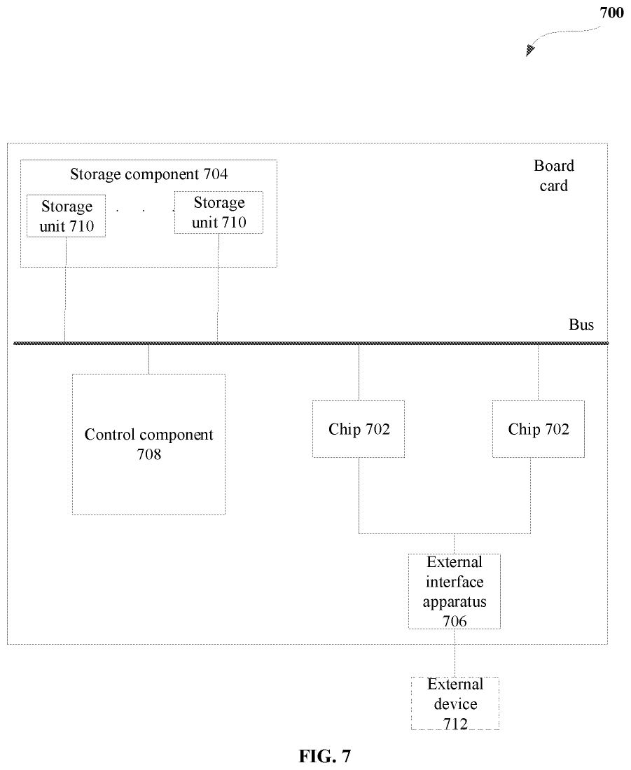

In other embodiments, the present disclosure also discloses a chip (such as a chip 702 shown in FIG. 7). In an implementation, the chip is a system on chip (SoC), and is integrated with one or a plurality of combined processing apparatuses as shown in FIG. 6. The chip may connect with other related components through an external interface apparatus (such as an external interface apparatus 706 shown in FIG. 7). The related components, for example, may be a camera, a monitor, a mouse, a keyboard, a network card, or a WIFI interface. In some application scenarios, other processing units (such as a video encoding and decoding apparatus) and/or interface units (such as a DRAM interface) may be integrated on the chip. In some embodiments, the present disclosure also provides a chip package structure, which includes the above mentioned chip. In some embodiments, the present disclosure also discloses a board card, which includes the above chip package structure. The following may describe the board card in detail in combination with FIG. 7.

FIG. 7 is a structural diagram of a board card 700, according to an embodiment of the present disclosure. As shown in FIG. 7, the board card includes a storage component 704 configured to store data, and the storage component 704 includes one or a plurality of storage units 710. The storage component may connect with a control component 708 and transfer data with the above mentioned chip 702 by using a bus or other methods. Further, the board card may include an external interface apparatus 706 configured to realize data relay or transferring function between the chip (or chip in the chip package structure) and an external device 712 (such as a server or a computer). For example, data to be processed is transferred from the external interface apparatus to the chip through an external device. For another example, a calculation result of the chip may be sent back to the external device through the external interface apparatus. According to different application scenarios, the external interface apparatus may have different interface forms. For example, the external interface apparatus may adopt a standard PCIE (peripheral component interface express) interface.

In one or a plurality of embodiments, a control component in a board card of the present disclosure may be configured to regulate a state of the chip. Therefore, in one application scenario, the control component may include an MCU (micro controller unit) configured to regulate the working state of the chip.

According to the above description in combination with FIG. 6 and FIG. 7, those of ordinary skill in the art may understand that the present disclosure also discloses an electronic device or apparatus, which may include one or a plurality of the above mentioned board cards, one or a plurality of the above mentioned chips and/or one or a plurality of the above mentioned combined processing apparatuses.

According to different application scenarios, the electronic device or apparatus may include a server, a cloud server, a server cluster, a data processing apparatus, a robot, a computer, a printer, a scanner, a tablet, a smart terminal, a PC device, an internet of things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous terminal, a vehicle, a household appliance, and/or a medical device. The vehicle includes an airplane, a ship, and/or a car; the household appliance may include a television, an air conditioner, a microwave oven, a refrigerator, an electric rice cooker, a humidifier, a washing machine, an electric lamp, a gas cooker, and a range hood; and the medical device may include a nuclear magnetic resonance spectrometer, a B-ultrasonic scanner, and/or an electrocardiograph. The electronic device or apparatus of the present disclosure may be applied to Internet, Internet of things, data center, resource, traffic, public management, manufacture, education, grid, telecommunication, finance, retail, construction site, medical fields, and the like. Further, the electronic device or apparatus of the present disclosure may be applied to cloud, edge, end and other application scenarios that are related to artificial intelligence, big data and/or cloud calculation. In one or a plurality of embodiments, electronic devices or apparatuses with high calculation capacity of the present disclosure may be applied to a cloud device (such as a cloud server). Electronic devices or apparatuses with low power consumption may be applied to a terminal device and/or an edge device (such as a smart phone or a webcam). In one or a plurality of embodiments, hardware information of the cloud device and/or hardware information of the edge device may be compatible with each other. Therefore, suitable hardware resources may be found from hardware resources of the cloud device to simulate hardware resources of the terminal device and/or hardware resources of the edge device according to hardware information of the cloud device and/or hardware information of the edge device, so as to realize unified management, schedule and cooperative work of end-cloud integration or cloud-edge-end integration.

It needs to be explained that for simplicity, the present disclosure expresses some methods and embodiments as a series of actions and combinations. Those of ordinary skill in the art may understand that technical solutions of the present disclosure are not limited by the order of described actions. Therefore, according to publicity or teaching of the present disclosure, those of ordinary skill in the art may understand that some steps may be performed by adopting other orders or may be performed at the same time. Further, those of ordinary skill in the art should also understand that the embodiments described in the present disclosure are all optional embodiments; in other words, the actions and units involved are not necessarily required for implementation of one or some technical solutions of the present disclosure. Besides, according to different technical solutions, the present disclosure describes some embodiments with different emphasis. Given that, those of ordinary skill in the art may understand a part that is not describe in detail in some embodiments may be described in other embodiments of the present disclosure.

In specific implementations, based on publicity and teaching of the present disclosure, those of ordinary skill in the art may understand the disclosed embodiments of the present disclosure may be implemented through other methods that are not disclosed in the present disclosure. For example, based on consideration of logic functions, each unit of the above mentioned electronic device or apparatus embodiments is divided, but there may be other division methods in actual implementations. For another example, a plurality of units or components may be combined together or integrated into another system, or some features or functions in the unit or component may be forbidden optionally. For connection relations between different units or components, connections discussed in combination with drawings may be direct or indirect coupling between units or components. In some scenarios, the above mentioned direct or indirect coupling relates to communication connection with utilization of an interface, where a communication interface may support electrical, optical, acoustic, magnetic or other types of signal transfer.

In the present disclosure, units described as separate components may or may not be physically separated, and components shown as units may or may not be physical units. The above mentioned components or units may be located in the same position or be distributed to a plurality of network units. In addition, according to real demands, some or all units may be selected for implementing the purposes of the technical solutions of embodiments in the present disclosure. In addition, in some scenarios, a plurality of units in embodiments of the present disclosure may be integrated into one unit, or each unit may physically exist alone.

In some implementation scenarios, the above mentioned integrated units may be implemented through adopting a form of software program unit. If the integrated units are implemented in the form of software program unit and sold or used as an independent product, the integrated units may be stored in a computer-readable memory. Based on such understanding, when the technical solutions of the present disclosure are implemented in the form of a software product (such as a computer readable storage medium), the software product may be stored in a memory. The software product may include a number of instructions to enable a computer device (such as a personal computer, a server, or a network device, and the like) to perform all or part of the steps of the methods described in embodiments of the present disclosure. The above mentioned memory includes but is not limited to: a USB flash drive, a flash disk, a read only memory (ROM), a random access memory (RAM), a mobile hard disk, a magnetic disk, or an optical disc, and other media that may store program code.

In some other implementation scenarios, the above mentioned integrated unit may be implemented through adopting the form of hardware, which is a specific hardware circuit that may include a digital circuit and/or a simulated circuit, and the like. Physical implementation of a hardware structure of the circuit includes, but is not limited to a physical component, and the physical component includes, but is not limited to, a transistor, a memristor, and the like. Given that, all types of apparatuses (such as a calculation apparatus or other processing apparatuses) described in the present disclosure may be implemented through suitable hardware processors, such as a CPU, a graphics processing unit (GPU), a field-programmable gate array (FPGA), a digital signal processor (DSP), and an application specific integrated circuit (ASIC). Further, the above mentioned storage unit or storage apparatus may be any suitable storage medium (including a magnetic storage medium or a magneto-optical storage medium), which may be a resistive random-access memory (RRAM), a dynamic random-access memory (DRAM), a static random access memory (SRAM), an enhanced dynamic random-access memory (EDRAM), a high-bandwidth memory (HBM), a hybrid memory cube (HMC), an ROM or an RAM, and the like.

The foregoing contents may be better understood according to the following articles:
Article 1. A calculation apparatus, comprising:
one group of a plurality of groups of pipeline calculation circuits configured to perform multi-stage pipeline calculation, wherein each group of the pipeline calculation circuits constitutes one multi-stage calculation pipeline, and the multi-stage calculation pipeline includes a plurality of calculation circuits that are arranged stage by stage,
wherein each stage of the calculation circuits in the multi-stage calculation pipeline is configured to perform one corresponding calculation instruction in a plurality of calculation instructions in response to the plurality of received calculation instructions,
wherein the plurality of calculation instructions are obtained through parsing the calculation instructions received by a calculation apparatus.
Article 2. The calculation apparatus of article 1, wherein an operation code of the calculation instruction represents a plurality of operations performed by the multi-stage calculation pipeline, and the calculation apparatus also includes a control circuit, which is configured to obtain the calculation instruction and parse the calculation instruction to obtain a plurality of calculation instructions corresponding to the plurality of operations.
Article 3. The calculation apparatus of article 2, wherein the operation code and the plurality of operations represented by the operation code are determined in advance according to supported functions by the plurality of calculation circuits that are arranged stage by stage in the multi-stage calculation pipeline.
Article 4. The calculation apparatus of article 1, wherein each stage of the calculation pipeline in the multi-stage calculation pipeline is configured to be optionally connected according to the plurality of calculation instructions to perform the plurality of calculation instructions.
Article 5. The calculation apparatus of article 1, wherein the plurality of groups of pipeline calculation circuits constitute a plurality of multi-stage calculation pipelines, and the plurality of multi-stage calculation pipelines perform their own plurality of calculation instructions in parallel.
Article 6. The calculation apparatus of article 1 or article 5, wherein each stage of the calculation circuits in the multi-stage calculation pipeline has an input end and an output end, which are respectively configured to receive input data at this stage of calculation circuits and output a result of operation of this stage of calculation circuits.
Article 7. The calculation apparatus of article 6, wherein in one multi-stage calculation pipeline, the output end of a one stage or multi-stage calculation circuits is configured to be connected to the input end of another one stage or multi-stage calculation circuits according to the calculation instruction to perform the calculation instruction.
Article 8. The calculation apparatus of article 6, wherein the plurality of multi-stage calculation pipelines include a first multi-stage calculation pipeline and a second multi-stage calculation pipeline, wherein the output end of a one stage or multi-stage calculation circuits of the first multi-stage calculation pipeline is configured to be connected to the input end of a one stage or multi-stage calculation circuits of the second multi-stage calculation pipeline according to the calculation instruction.
Article 9, The calculation apparatus of article 1, wherein each stage of the calculation circuits includes one or a plurality of operators or circuits in the following:
a random number processing circuit, an adding and subtracting circuit, a subtracting circuit, a look-up table circuit, a parameter configuration circuit, a multiplier, a pooler, a comparator, an absolute value circuit, a logic operator, a position index circuit or a filter.
Article 10. The calculation apparatus of article 1 also includes a data processing circuit, which includes a type conversion circuit configured to perform a data type conversion operation and/or a data concatenation circuit configured to perform data concatenation operation.
Article 11. The calculation apparatus of article 10, wherein the type conversion circuit includes one or a plurality of converters configured to realize a conversion of calculation data among a plurality of different data types.
Article 12. The calculation apparatus of article 10, wherein the data concatenation circuit is configured to split the calculation data according to a predetermined bit length, and splice a plurality of data blocks obtained after the partition according to a predetermined order.
Article 13. An integrated circuit chip, comprising the calculation apparatus of any one of article 1 to article 12.
Article 14. A board card, comprising the integrated circuit chip of article 13.
Article 15. An electronic device, comprising the integrated circuit chip of article 13.
Article 16. A method, using a calculation apparatus to perform a calculation, wherein the calculation apparatus comprises one group or a plurality of groups of pipeline calculation circuits, and the method comprises:
configuring each group of the calculation circuits in the one group or the plurality of groups of pipeline calculation circuits to perform multi-stage pipeline calculation, wherein each group of the pipeline calculation circuits constitutes one multi-stage calculation pipeline, and the multi-stage calculation pipeline includes a plurality of calculation circuits that are arranged stage by stage; and
configuring each stage of the calculation circuits in the multi-stage calculation pipeline to perform one corresponding calculation instruction in a plurality of calculation instructions in response to receiving the plurality of calculation instructions,
wherein the plurality of calculation instructions are obtained through parsing the calculation instructions received by the calculation apparatus.
Article 17. The method of article 16, wherein an operation code of the calculation instruction represents a plurality of operations performed by the multi-stage calculation pipeline, and the calculation apparatus includes a control circuit, and the method includes configuring the control circuit to obtain the calculation instruction and parse the calculation instruction to obtain the plurality of calculation instructions corresponding to the plurality of operations.
Article 18. The method of article 17, wherein the operation code and the plurality of operations represented by the operation code are determined in advance according to supported functions by the plurality of calculation circuits that are arranged stage by stage in the multi-stage calculation pipeline.
Article 19. The method of article 16, wherein each stage of the calculation circuits in the multi-stage calculation pipeline is configured to be optionally connected according to the plurality of calculation instructions to perform the plurality of calculation instructions.
Article 20. The method of article 16, wherein the plurality of groups of calculation circuits constitute a plurality of multi-stage calculation pipelines, and the plurality of multi-stage calculation pipelines perform their own plurality of calculation instructions in parallel.
Article 21. The method of article 16 or article 20, wherein each stage of the calculation circuits in the multi-stage calculation pipeline has an input end and an output end, which are respectively configured to receive input data at this stage of calculation circuit and output a result of operation of this stage of calculation circuits.
Article 22. The method of article 21, wherein in one multi-stage calculation pipeline, an output end of one stage or multi-stage calculation circuits is configured to be connect to an input end of another one stage or multi-stage calculation circuits according to the calculation instruction to perform the calculation instruction.
Article 23. The method of article 21, wherein the plurality of multi-stage calculation pipelines include a first multi-stage calculation pipeline and a second multi-stage calculation pipeline, wherein the method configures an output end of one stage or multi-stage calculation circuits of a first multi-stage calculation pipeline to be connected to an input end of one stage or multi-stage calculation circuits of a second multi-stage calculation pipeline according to the calculation instruction.
Article 24, The method of article 16, wherein each stage of the calculation circuits includes one or a plurality of operators or circuits in the following:
a random number processing circuit, an adding and subtracting circuit, a subtracting circuit, a look-up table circuit, a parameter configuration circuit, a multiplier, a pooler, a comparator, an absolute value circuit, a logic operator, a position index circuit or a filter.
Article 25. The method of article 16 also includes a data processing circuit, which includes a type conversion circuit configured to perform a data type conversion operation and/or a data concatenation circuit configured to perform a data concatenation operation.
Article 26. The method of article 25, wherein the type conversion circuit includes one or a plurality of converters configured to realize conversion of calculation data among a plurality of different data types.
Article 27. The method of article 25, wherein the data concatenation circuit is configured to split the calculation data according to a predetermined bit length, and splice a plurality of data blocks obtained after the partition according to a predetermined order.

Even though the present disclosure has already shown and described a plurality of embodiments of the present disclosure, it is obvious for those of ordinary skill in the art that such embodiments are only provided through the method of examples. Those of ordinary skill in the art may conceive many changes and substitute methods without deviating ideas and spirits of the present disclosure. It should be understood that in the process of implementing the present disclosure, every kind of substitute schemes of the embodiments of the present disclosure described may be adopted. Accompanying claims aim at limiting protection scope of the present disclosure, and may cover equivalent or substitute schemes in the scope of these claims.

1. A calculation apparatus comprising:
one group or a plurality of groups of pipeline calculation circuits configured to perform a multi-stage pipeline calculation, wherein each group of the pipeline calculation circuits constitutes one multi-stage calculation pipeline, and the multi-stage calculation pipeline includes a plurality of calculation circuits that are arranged stage by stage,
wherein each stage of the calculation circuits in the multi-stage calculation pipeline is configured to perform one corresponding calculation instruction in a plurality of calculation instructions in response to receiving the plurality of calculation instructions,
wherein the plurality of calculation instructions are obtained through parsing the calculation instructions received by the calculation apparatus.

2. The calculation apparatus of claim 1, wherein an operation code of the calculation instruction represents a plurality of operations performed by the multi-stage calculation pipeline, and the calculation apparatus also includes a control circuit configured to obtain the calculation instruction and parse the calculation instruction to obtain a plurality of calculation instructions corresponding to the plurality of operations.

3. The calculation apparatus of claim 2, wherein the operation code and the plurality of operations represented by the operation code are determined in advance according to supported functions by the plurality of calculation circuits that are arranged stage by stage in the multi-stage calculation pipeline.

4. The calculation apparatus of claim 1, wherein each stage of the calculation circuits in the multi-stage calculation pipeline is configured to be optionally connected according to the plurality of calculation instructions to perform the plurality of calculation instructions.

5. The calculation apparatus of claim 1, wherein the plurality of groups of pipeline calculation circuits constitute a plurality of multi-stage calculation pipelines, and the plurality of multi-stage calculation pipelines perform their own plurality of calculation instructions in parallel.

6. The calculation apparatus of claim 1, wherein each stage of the calculation circuits in the multi-stage calculation pipeline has an input end and an output end, which are respectively configured to receive input data at this stage of calculation circuit and output a result of operation of this stage of calculation circuits.

7. The calculation apparatus of claim 6, wherein in one multi-stage calculation pipeline, the output end of one stage or multi-stage calculation circuits is configured to be connected to the input end of another one stage or multi-stage calculation circuits according to the calculation instruction to perform the calculation instruction.

8. The calculation apparatus of claim 6, wherein the plurality of multi-stage calculation pipelines include a first multi-stage calculation pipeline and a second multi-stage calculation pipeline, wherein an output end of one stage or multi-stage calculation circuits of the first multi-stage calculation pipeline is configured to be connected to an input end of one stage or multi-stage calculation circuits of the second multi-stage calculation pipeline according to the calculation instruction.

9. The calculation apparatus of claim 1, wherein each stage of the calculation circuits includes one or a plurality of following operators or circuits:
a random number processing circuit, an adding and subtracting circuit, a subtracting circuit, a look-up table circuit, a parameter configuration circuit, a multiplier, a pooler, a comparator, an absolute value circuit, a logic operator, a position index circuit, or a filter.

10. The calculation apparatus of claim 1, further comprising a data processing circuit, which includes a type conversion circuit configured to perform a data type conversion operation and/or a data concatenation circuit configured to perform data concatenation operation.

11. The calculation apparatus of claim 10, wherein the type conversion circuit includes one or a plurality of converters configured to realize a conversion of calculation data among a plurality of different data types.

12. The calculation apparatus of claim 10, wherein the data concatenation circuit is configured to split the calculation data according to a predetermined bit length and splice a plurality of data blocks obtained after the partition according to a predetermined order.

13. An integrated circuit chip comprising the calculation apparatus of claim 1.

14. (canceled)

15. (canceled)

16. A method, using a calculation apparatus to perform a calculation, wherein the calculation apparatus includes one group or a plurality of groups of pipeline calculation circuits, the method comprising:
configuring each group of the calculation circuits in the one group or the plurality of groups of pipeline calculation circuits to perform multi-stage pipeline calculation, wherein each group of the pipeline calculation circuits constitutes one multi-stage calculation pipeline, and the multi-stage calculation pipeline includes a plurality of calculation circuits that are arranged stage by stage; and
configuring each stage of the calculation circuits in the multi-stage calculation pipeline to perform one corresponding calculation instruction in a plurality of calculation instructions in response to receiving the plurality of calculation instructions,
wherein the plurality of calculation instructions are obtained through parsing the calculation instructions received by the calculation apparatus.

17. The method of claim 16, wherein an operation code of the calculation instruction represents a plurality of operations performed by the multi-stage calculation pipeline, and the calculation apparatus includes a control circuit, and the method includes configuring the control circuit to obtain the calculation instruction and parse the calculation instruction to obtain the plurality of calculation instructions corresponding to the plurality of operations.

18. The method of claim 17, wherein the operation code and the plurality of operations represented by the operation code are determined in advance according to supported functions by the plurality of calculation circuits that are arranged stage by stage in the multi-stage calculation pipeline.

19. The method of claim 16, wherein each stage of the calculation circuits in the multi-stage calculation pipeline is configured to be optionally connected according to the plurality of calculation instructions to perform the plurality of calculation instructions.

20. The method of claim 16, wherein the plurality of groups of calculation circuits constitute a plurality of multi-stage calculation pipelines, and the plurality of multi-stage calculation pipelines perform their own plurality of calculation instructions in parallel.

21. The method of claim 16, wherein each stage of the calculation circuits in the multi-stage calculation pipeline has an input end and an output end, which are respectively configured to receive input data at this stage of calculation circuits and output a result of operation of this stage of calculation circuits.

22. The method of claim 21, wherein in one multi-stage calculation pipeline, the output end of one stage or multi-stage calculation circuits is configured to be connect to the input end of another one stage or multi-stage calculation circuits according to the calculation instruction to perform the calculation instruction.

23. (canceled)

24. (canceled)

25. (canceled)

26. (canceled)

27. (canceled)
